(19) United States
(12) Patent Application Publication
(10) Pub. No.: US 2016/0143343 A1
(43) Pub. Date: May 26, 2016

(54) METHOD AND INJECTOR FOR INTRODUCING A VAPOROUS HEAT CARRIER INTO A LIQUID PRODUCT

(71) Applicant: GEA TDS GMBH, Sarstedt (DE)

(72) Inventors: Andreas Schmied, Dülmen (DE); Jürgen Gehling, Stadtlohn (DE); Stephan Stockhorst, Rhede (DE); Uwe Schwenzow, Ahaus (DE); Ludger Tacke, Velen (DE)

(21) Appl. No.: 14/899,837

(22) PCT Filed: May 24, 2014
(86) PCT No.: PCT/EP2014/001411

§ 371 Date: Dec. 18, 2015

(30) Foreign Application Priority Data
Jun. 19, 2013 (DE) 10 2013 010 296.0

(51) Int. Cl. A23L 3/22

(52) U.S. Cl. CPC A23L 3/22; A23V 2002/00

(57) ABSTRACT

A method for introducing a vaporous heat carrier into a liquid product, in particular a food product or beverage, and more particularly viscous products, for example desserts, sauces or concentrates, includes using the carrier to heat the product to form a germ-free product. An injector for carrying out the method is also described. A reduction in the heat transfer capacity of the injector is prevented over the entire production time. This is achieved in that three physical measurement variables which can be detected during operation of the injector are used as indicators of the formation of product deposits. At least one of said three physical measurement variables is detected, and depending on these variables, an automatically controlled axial movement of the displacement body is carried out such that the heat transfer capacity from the vaporous heat carrier into the liquid product remains the same.

### TECHNICAL FIELD

The disclosure relates to a method for introducing a vaporous heat carrier into a liquid product, in particular a food product or beverage, and in this case in particular viscous products, for example desserts, sauces or concentrates, where the vaporous heat carrier heats the liquid product in order to form a germ-free product and relates to an injector for carrying out said method.

### BACKGROUND

With respect to the heat treatment of a liquid product of the aforementioned type, qualitatively correct water vapor of drinking water quality, preferably so-called culinary water vapor in the saturation state, can be used to heat the liquid product quickly and efficiently. One of the methods used to directly inject vapor into the liquid product consists in the use of an injector. As a result of this fast process, the treatment time can be reduced, which leads overall to reduced heat impact on the product and whereby a product is obtained that has a higher quality level above all in terms of taste. The fast and gentle heat treatment during the direct heating process is achieved at the cost of a higher energy expenditure with respect to the indirect heating process, for example by means of tube bundle heat exchanger. One thus tries to further improve the heat transfer conditions during the direct process of the type in question, which then inevitably leads to a reduced required temperature difference between the vaporous heat carrier and the liquid product to be heated and thus further benefits the gentle treatment of the product.

A method and an injector for carrying out the method are known from DE 10 2007 017 704 A1. However, the method and the injector concern only one configuration, in which the flow of the vaporous heat carrier is generated through a decrease in pressure, which occurs through the speed of the liquid product.

DE 10 2007 017 704 A1 discloses that the axial displacement of a displacement body is performed manually or in a motor-driven manner. The manual displacement takes place for example via a lockable (for example securable) spindle nut system. A motor-driven displacement can take place via a motor-driven spindle nut system, wherein the actuating drive is operated for example electrically, pneumatically or hydraulically and generates the necessary rotational movement of the spindle.

### SUMMARY

In the case of known injectors, determined by the thermal heating of the product, with the production period and with different intensity, product deposits can form in the injector, in particular on the hot components coming in contact with the product. In the present disclosure, an annular-channel-shaped mixing chamber is particularly desirable to address this, and is formed between a spiniform displacement body and the product-loaded injector housing surrounding it. The radial extension of the mixing chamber determines the layer thickness of the product to be heated and thus decisively also the heat input and heat transfer conditions of the vaporous heat carrier into the product.

The tendency toward the formation of deposits is product specific and has been shown to be particularly significant in viscous products. Through deposits on the components that are contacted by the product, the product speed and the heat input inevitably change in the annular-channel-shaped mixing chamber and the heat transfer of the injector is lowered. These changes have repercussions on the temperature and thus on the pressure of the vaporous heat carrier at the inlet into the injector; both state variables increase, whereby the tendency towards the formation of deposits increases further. In the vaporous heat carrier, this concerns saturated vapor or overheated vapor.

If overheated vapor is used, then the enthalpy of the vapor, starting from the saturated vapor area, cannot generally be fully transferred in the injector. The condensation path within the annular-channel-shaped mixing chamber in the injector is thus insufficient for this. For this reason, a higher temperature of the product often results at the end of a heat-retaining path subordinate to the injector with respect to the outlet from the injector. This insufficiency is known as re-evaporation and is undesirable.

The object of the present invention is to provide a method and an injector for carrying out said method, with which method and injector the disadvantages and insufficiencies of the state of the art are remedied and, in particular, a reduction in the heat transfer capacity of the injector is prevented over the entire production period.

The inventive solution is based on the realization that the radial extension of the annular-channel-shaped mixing chamber of the injector, which forms the product layer thickness and decisively impacts the heat input and heat transfer conditions of the vaporous heat carrier to the liquid product to be heated and which is in turn significantly changed by the product deposits, is used as a variable for controlling and/or regulating the heat transfer capacity. The radial extension can be changed through axial movement of a spiniform displacement body, which is designed in a conically tapering manner in the area of the mixing chamber, seen in the direction of flow, and corresponds with an also conically tapering injector housing, which surrounds the displacement body. A movement of the displacement body in the direction of flow thus effectuates a reduction and a movement opposite the direction of flow effectuates an enlargement of the passage cross-sections of the mixing chamber.

Based on this realization, three physical measurement variables which can be detected during operation of the injector are used as indicators of the formation of product deposits. At least one of said three physical measurement variables is detected, and, depending on one or more of these physical measurement variables, an automatically controlled axial movement of the displacement body is carried out in such a way that the heat transfer capacity from the vaporous heat carrier into the liquid product remains the same.

These physical measurement variables concern an oscillation frequency of the entire injector or of a selected part of it generated and forced by the flow in the injector, a temperature difference between the inlet temperature of the vaporous heat carrier at the inlet into the injector and the outlet temperature of the heated liquid product at the outlet from the injector, or a pressure difference between the inlet pressure of the vaporous product carrier at the inlet into the injector and the outlet pressure of the heated liquid product at the outlet from the injector.

Through the procedural characteristics suggested according to the invention, the product layer thickness in the annular-channel-shaped mixing chamber can be changed in particular in viscous products and the product speed and the heat input and heat transfer conditions can thus be decisively impacted. Thus, in a particularly advantageous and effective manner, the product layer thickness in concentrates can be optimally adjusted such that a complete condensation of the saturated vapor is achieved. Through the automated axial movement of the spiniform displacement body, it is possible to adjust or respectively regulate the product layer thickness during production in its radial extension. The product layer thickness can thereby also be set and regulated for each product individually.

After a production period that cannot be exactly predicted, determined by the thermal heating of the product, product deposits can result on the components of the injector contacted by the product. These effectuate the following in the further temporal progression: an increase in the aforementioned temperature difference, and an increase in the aforementioned pressure difference depending on this temperature difference, and the occurrence of forced oscillations of the entire injector or parts of it, which has not yet been paid attention to in the state of the art and/or the causal connection with the formation of product deposits of the type in question which the technical world has not identified to date.

The occurrence of these forced oscillations through changing flow-mechanical and thermal conditions in the injector is described herein to control or respectively regulate the heat transfer capacity. This occurs in that these oscillations are captured and used to trigger a signal for the automatically controlled or respectively regulated movement of the displacement body.

The signal, resulting from the oscillations and/or the temperature and/or the pressure difference, is delivered to a control unit. In compliance with a control program stored in it, this control unit moves the displacement body axially in a manner so that the body is extended a bit out of the annular-channel-shaped mixed chamber. Thereby, the chamber's radial extension, previously restricted, increases and the product speed is inevitably correspondingly reduced. This then leads to the removal of the product deposits, and the measurement variable used for the control or respectively regulation changes.

If the forced oscillations are used as the actuating or respectively control variable, then they subside. The movement of the displacement body is thereby controlled or respectively regulated precisely, for example with an accuracy of 0.1 mm. After this limited period of time, the displacement body can then be returned to its initial position and the control or respectively regulation cycle described above can begin again, whereby a longer continuous production time results.

Alternatively or in addition to the use of the oscillation frequency as the regulation or control variable, it is also suggested to use the temperature difference described above. This temperature difference is measured during ongoing production. The increase in the temperature difference indicates growing product deposits in the injector. In the case of an increasing temperature difference, the temperature of the vaporous heat carrier also increases. If now, during production, the radial extension of the annular-channel-shaped mixing chamber increases, which results in a change in the product speed, in that the displacement body is automatically extended, the vaporous heat carrier can then penetrate into the product easier. This leads to a pressure reduction on the vapor side and thus in turn to a lower vapor temperature. The lower the vapor temperature, the less product deposits form.

Alternatively or in addition to the use of the oscillation frequency as the regulation or control variable, it is also suggested to use the temperature difference described above. This pressure difference is measured during ongoing production. The increase in the pressure difference also indicates product deposits in the injector. Here as well, the displacement body is automatically extended; the vapor pressure is thereby lowered, whereby the pressure difference is reduced. The temperature difference is thus inevitably reduced, and the product deposits are reduced or respectively minimized.

In the case of heating systems for drying towers, the product performance at the start of production is considerably lower than the nominal capacity of the drying system. Here as well, the movement of the displacement body according to the description herein can ensure that, despite changed performance, the heating performance in the injector remains the same. This measure secures the condensation processes and continuous production time.

For each recipe, product-specific parameters can be stored in the control program. The described movement of the displacement body can thus be adjusted for individual products in a fully automated manner and the previously determined dependencies can be met over the entire production period.

If the injector is operated with overheated vapor, then the enthalpy of the vapor, starting from the saturated vapor area, cannot generally be fully transferred in the injector. The condensation path within the injector is not usually sufficient for this. For this reason, a higher temperature often results at the outlet of a heat-retaining path subordinate to the injector with respect to the outlet temperature of the heated liquid product at the outlet from the injector. As provided herein, this insufficiency is remedied in that the automatically controlled movement of the displacement body described above is performed when the temperature at the outlet of the heat-retaining path is exceeded with respect to the outlet temperature of the heated liquid product at the outlet from the injector by a specified permissible temperature difference, for example 1°C. This intervention helps to reduce the temperature difference.

Embodiments of the invention further suggest that the heating of the liquid product by the vaporous heat carrier takes place in more than one mixing chamber, which are connected in series in the direction of flow. This means that the method according to the description herein can also be used on multi-stage injectors.

An injector generally suitable for carrying out the method according to the invention in a configuration where flow of a vaporous heat carrier is generated through a decrease in pressure, which occurs through the speed of the liquid product is known from DE 10 2007 017 704 A1, because a motor-driven movement of the displacement body is already provided there. In contrast, the invention provides, starting from an injector of this type, that the displacement body is connected with an actuating drive via an adjusting rod, and that a control unit is provided in which the physical measurement variables (oscillation frequency and/or temperature difference and/or pressure difference) are saved and in which a control program is stored. The control unit performs an automatically controlled or respectively regulated axial adjustment movement of the adjusting rod according to specifications by the control program and depending on one or more of the physical measurement variables.

According to a preferable embodiment, an oscillation sensor is arranged directly or indirectly on the injector housing. Since the forced oscillations caused by product deposits develop on the spiniform displacement body in a significant manner, it is provided that the oscillation sensor is connected directly or indirectly to the adjusting rod.

The product deposits are released easier from the product-pressurized components of the injector with a simultaneously high temperature and cleaning agent resistance when these components are made of polyether ether ketone (PEEK).

### BRIEF DESCRIPTION OF THE DRAWINGS

A more detailed representation of the invention results from the following description and the attached FIGS. of the drawing as well as from the claims. While the invention is realized in various designs of a method and in the design of a single-stage or multi-stage injector for carrying it out, the drawing describes preferred embodiments of two injectors for carrying out a preferred design of the method.

FIG. 1 is a meridian cut through a single-stage injector according to an embodiment of the invention.

FIG. 2 is a perspective representation of a multi-stage injector according to an embodiment of the invention cut open in its meridian plate.

FIG. 3 is a meridian cut through the injector according to FIG. 2 (the viewing direction being perpendicular to the sectional plane of FIG. 2).

### DESCRIPTION

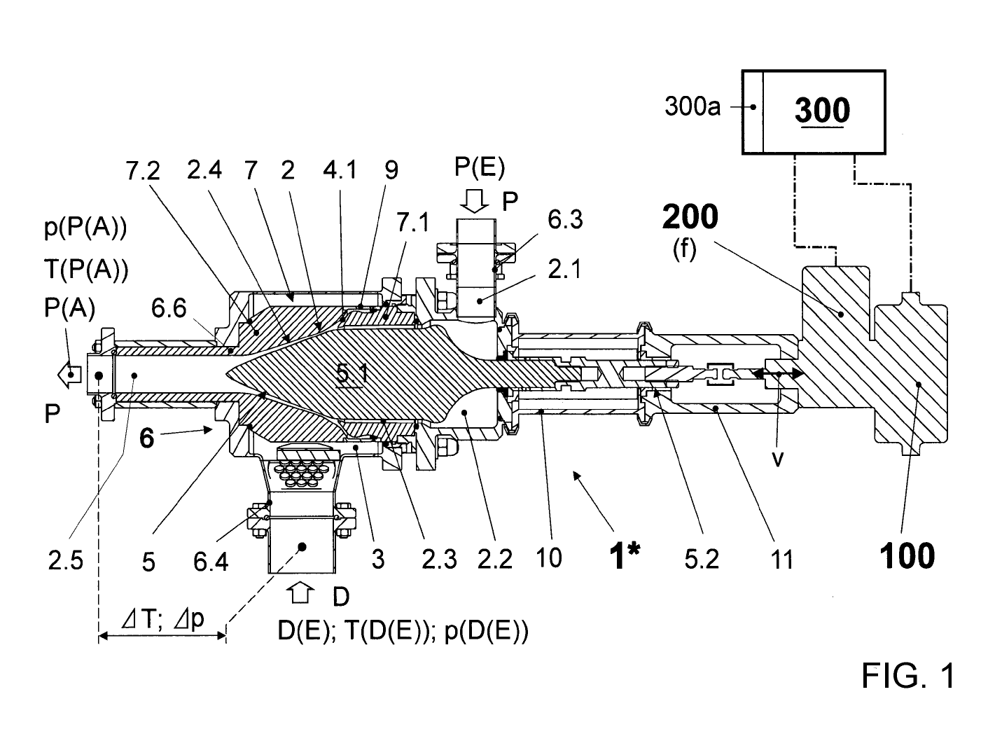

### Single-Stage Injector (FIG. 1)

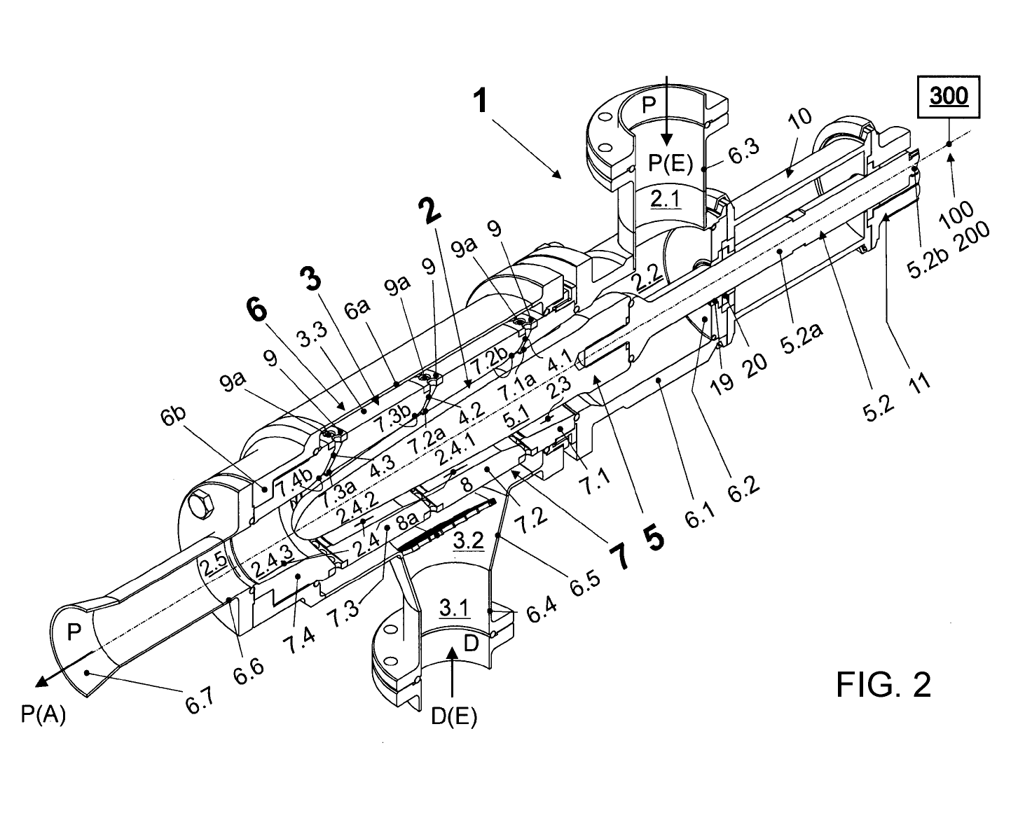

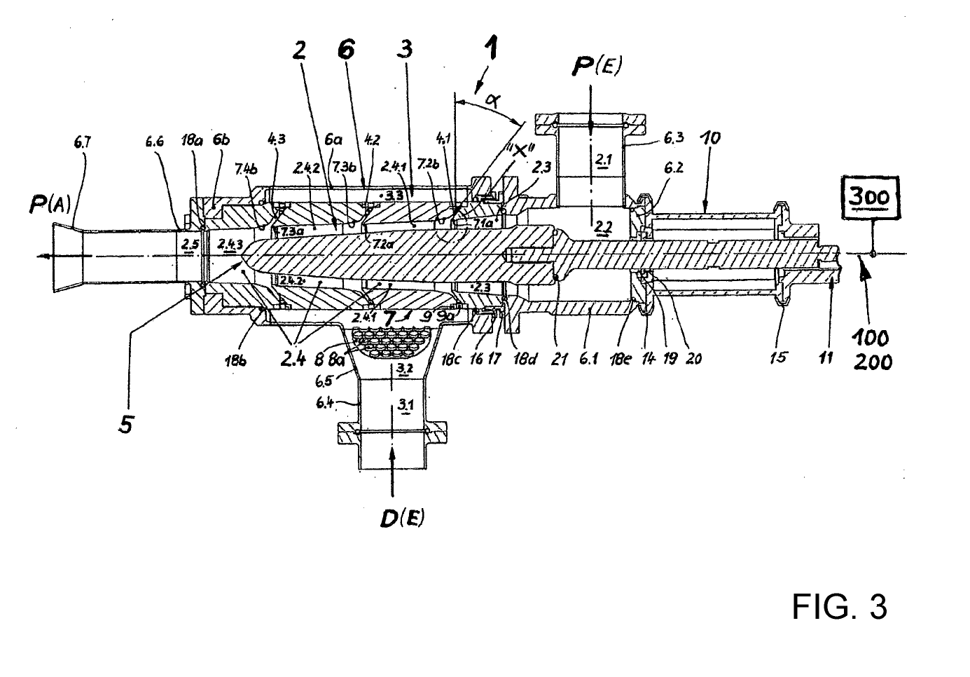

The basic functionality of an injector is first described based on a single-stage injector 1* according to FIG. 1. Details about its structure, which are shown there but not labeled and described, can be found in the description for a multi-stage injector 1 according to FIGS. 2 and 3. The reference numbers and the associated descriptions are used uniformly in all figures.

A liquid product P flows, referring to the drawing position, from above perpendicularly to a first inlet 6.3 (dome) arranged centrically on an injector housing 6 with a product inlet P(E) and arrives via a cylindrical first inlet space 2.1 in the rear space of the injector 1*, an inlet chamber 2.2, where the liquid product P is evenly distributed over a perimeter of the inlet chamber 2.2 and is fed from there to a first pressurization space 2. An even product layering takes place in an annular gap, a first inner annular space 2.3, which is formed between a displacement body 5.1 of a mandrel 5 and a first product-side housing ring 7.1 of an inner housing 7, which defines the displacement body 5.1. The first inner annular space 2.3 is part of the first pressurization space 2. The latter is designed between the displacement body 5.1 and the inner housing 7, consisting of the first housing ring 7.1 and a second housing ring 7.2, and namely on its entire axial length. The liquid product P leaves the first inner annular space 2.3 on its further flow path and arrives in an annular-channel-shaped mixing chamber 2.4. The mixing chamber 2.4 begins, seen in the direction of flow, in the area of the transition of the cylindrical to the conical design of the displacement body 5.1.

In the mixing chamber 2.4, a vaporous heat carrier D, preferably saturated vapor, meets the liquid product P, wherein the flow of the vaporous heat carrier D is caused by a pressure drop, which occurs through the speed of the liquid product P during the transition from the first inner annular space 2.3, tapering in a nozzle-like manner, into the annular-channel-shaped mixing chamber 2.4. The vaporous heat carrier D arrives in this area when it enters a second pressurization space 3, which surrounds the first pressurization space 2 concentrically, at a vapor inlet D(E) via a second inlet 6.4 and from there, via a distributor ring 9 within the inner housing 7, pressurizes the mixing chamber 2.4 circumferentially from outside via a (first) ring nozzle 4.1.

Effective mixing of the liquid product P with the vaporous heat carrier D with simultaneous condensation of the vaporous heat carrier D takes place in the mixing chamber 2.4, and the liquid product P to be heated is accelerated there in a process-driven manner, whereby the mixing is sped up. The conically tapering mixing chamber 2.4 flows into a cylindrical outlet space 2.5, a so-called condensation path, and supplies to the cylindrical outlet space 2.5 the two-phase mixture of liquid product P and not yet condensed vaporous heat carrier D. The heated liquid product P leaves the cylindrical outlet space 2.5, which is preferably designed as a piece of straight tubing, at a product outlet P(A) formed by an outlet 6.6. Polyether ether ketone (PEEK) is preferably used as the material for the cylindrical outlet space 2.5, as well as for other components of the injector 1* coming in contact with the hot product P. Due to its special properties, this material reduces the tendency for the formation of product deposits and burning and has been proven to be temperature- and cleaning-agent-resistant.

The mandrel 5 consists on one side of the displacement body 5.1 ending in front of the cylindrical outlet space 2.5 and on the other side of an adjusting rod 5.2 shaped on the displacement body 5.1. The mandrel 5 is fed through a lamp housing permanently connected with the injector housing 6 and a fastening part 11 connecting to the lamp housing directly or via an extension connecting with the lamp housing in a form- and/or force-fitting manner and connected with an actuating drive 100, which is mounted on the fastening part 11. With the help of the actuating drive 100, the adjusting rod 5.2 and thus the displacement body 5.1 can be moved in the axial direction by an adjustment movement v. With this adjustment movement v, the displacement body 5.1 can be moved very precisely, for example with an accuracy of 0.1 mm, into or out of the mixing chamber 2.4.

An oscillation sensor 200, with which the oscillations occurring on or in the injector 1*, for example their vibration frequency f, are captured, is arranged directly on the injector housing 6 or, as shown in the exemplary embodiment, indirectly on the injector housing 6, namely preferably in the connection area of the fastening part 11 with the actuating drive 100. The arrangement can be advantageously made so that the oscillation sensor 200 is connected directly or indirectly with the adjusting rod 5.2, on which excited, forced oscillations develop in a special manner through the flow and the thermal conditions in the injector 1*. This oscillation sensor 200 can be designed for example as a vibration switch, which only determines whether oscillations (vibrations) occur, and which generates a switch signal when a predetermined amplitude is exceeded or fallen short of. Oscillation sensor 200 and actuating drive 100 are connected with a control unit 300, in which a control program 300a is stored. Product-specific parameters for controlling or respectively regulating the adjustment movement v are stored in this control program 300a, with which the axial displacement of the displacement body 5.1 can be automatically controlled or respectively regulated such that the heat transfer capacity from the vaporous heat carrier D into the liquid product P remains the same.

It is further provided that a temperature difference ΔT and/or a pressure difference Δp is measured between the second inlet 6.4 and the product outlet P(A) and, just like the information on the oscillations, generated via the oscillation sensor 200, is or respectively are supplied to the control unit 300.

### Multi-Stage Injector (FIGS. 2 and 3)

A multi-stage injector 1 (we hereinafter refer respectively to the most suitable of FIG. 2 or 3 and positional information refers to the representation position of the injector 1) is bordered on the outside by a tubular injector housing 6, which concentrically surrounds an annular inner housing 7 with a cylindrical casing part 6a, reaches partially around the annular inner housing 7 with a collar part 6b, and ends on the right side in a flange (not described in greater detail). The tubular injector housing 6 is sealed radially on the inside in the area of the right-side end of the inner housing 7 with respect to the flange via a third housing seal 18c (FIG. 3). An outer annular space 3.3, which is part of a second pressurization space 3 for preparing and distributing a vaporous heat carrier D, is formed between the outer casing surface of the inner housing 7 and the casing part 6a. The vaporous heat carrier D concerns in particular water vapor, preferably so-called culinary water vapor in the saturation state (saturated vapor), which is supplied to the second pressurization space 3, starting from a vapor inlet D(E), via a second inlet 6.4, which forms a preferably cylindrical second inlet space 3.1 on the inside, and a flush-connecting, preferably conical expansion fitting 6.5, which forms a correspondingly conically expanded space 3.2 on the inside. The longitudinal axis of the expansion fitting 6.5 ends in the second pressurization space 3 slightly to the right of the center of the axial length of the latter. The second pressurization space 3 is sealed to the outside on its left-side end via a second housing seal 18b, which is clamped axially/radially between the injector housing 6 and the inner housing 7. The right-side end of the inner housing 7 projects slightly beyond the right-side front surface of the flange on the injector housing 6 and is sealed there axially on the front side with respect to an inlet housing 6.1 via a fourth housing seal 18d. The inlet housing 6.1 forms a flange (not described in greater detail), which is screwed to the corresponding flange on the injector housing 6, at the sealing point with the inner housing 7.

A mandrel 5 relocatable in the axial direction, which is designed in its left-side part in the form of a mainly conical, rotationally symmetrical displacement body 5.1 that tapers towards the left-side end and engages with the annular inner housing 7 from the right (FIG. 2). An annular-channel-shaped mixing chamber 2.4, which is part of a first pressurization space 2 for the liquid product P, is formed between the displacement body 5.1 and the annular inner housing 7 surrounding the displacement body 5.1. A first inner annular space 2.3, which is also part of the first pressurization space 2, is formed between the right-side end of the inner housing 7 and the displacement body 5.1, tapers in a nozzle-like manner in the direction of the mixing chamber 2.4 and is directly connected with an inlet chamber 2.2 designed in the inlet housing 6.1 that attaches on the right side to the mixing chamber 2.4.

The inlet housing 6.1 has a first inlet 6.3 for supplying the liquid product P, which preferably forms a cylindrical first inlet space 2.1 on the inside, wherein the cylindrical first inlet space 2.1 is directly connected with the inlet chamber 2.2. A product inlet P(E) into the first pressurization space 2 thus takes place at the first inlet 6.3 and the liquid product P then arrives in the mixing chamber 2.4 via the inlet space 2.1, the connecting inlet chamber 2.2, and the first inner annular space 2.3 tapering in a nozzle-like manner, in order to exit the mixing chamber 2.4 via a preferably cylindrically designed outlet space 2.5, which is formed in an outlet 6.6 connecting to the collar part 6b on the left side. The outlet space 2.5 lengthens into a tube section, preferably with the same diameter, which serves as a so-called condensation path. The condensation path leads into a tube extension 6.7, via which a product outlet P(A) into a discharging tube of a subordinate processing system takes place.

A flange designed on the outlet 6.6 (not described in greater detail) is preferably screwed with the collar part 6b and this flange is sealed axially from a corresponding, front-side boundary surface of the inner housing 7 via a first housing seal 18a. The collar part 6b is thus fixed both axially and radially in a form-fitting manner between the flange on the outlet 6.6 and the inner housing 7, and the entire aggregation, consisting of the parts 6, 6.6 with 6.7, 7 and 6.1 with 6.3, is held together by the screw connection between the flange on the injector housing 6 and the flange on the inlet housing 6.1, self-tensioned and sealed toward the outside at the mentioned sealing points 18a to 18d.

A first clamping bushing 16 engages from the right into the bore hole in the flange on the injector housing 6, contacts the third housing seal 18c on the flange end and clasps with a collar the flange on the injector housing 6. The first clamping bushing 16 is screwed on the inside with a second clamping bushing 17, wherein the second clamping bushing 17, on its right-side end with an unlabeled collar, engages radially inward in a form-fitting manner in an unlabeled groove-like recess between the front surface of the inner housing 7 and the flange on the inlet housing 6.1. The contact pressure of housing seals 18a, 18b and 18c as well as the axial contact pressure between the housing rings described below, from which the inner housing 7 is advantageously composed, can be set with this clamping bushing arrangement 16/17 in cooperation with the screw connection between the flange on the injector housing 6 and the flange on the inlet housing 6.1. Moreover, the collar on the second clamping bushing 17 centers the inlet housing 6.1 with respect to the inner housing 7, wherein the inlet housing 6.1 including the fourth housing seal 18d abuts metallically against the inner housing 7.

The first pressurization space 2 is closed on the right-side end of the inlet housing 6.1 by a cover 6.2, which is sealed in an opening in the inlet housing 6.1 via a fifth housing seal 18e and is preferably fixed there in form- and force-fitting manner via a clamping flange (not described in greater detail) on a lamp housing 10 by means of a first clamping ring 14. An adjusting rod 5.2, which is sealed from the displacement body 5.1 at the spot of the screw connection by means of a seal 21, is screwed into the displacement body 5.1 on the right side. In its left-side part, the adjusting rod 5.2 consists of a guide rod 5.2a with a larger diameter and, in its right-side part, the adjusting rod 5.2 consists of a fastening rod 5.2b with a smaller diameter (FIG. 2). The guide rod 5.2a penetrates the cover 6.2 and the flange on the lamp housing 10 via a rod seal 19 and a connecting guide ring 20. A fastening part 11 is flange-mounted on the right side on the lamp housing 10, wherein this connection is formed with a second clamping ring 15, similar to any connection between cover 6.2 and lamp housing 10. The adjusting rod 5.2 is connected with the fastening rod 5.2b with the actuating drive 100, as is shown in FIG. 1. Through this arrangement, the mandrel 5 is to be displaced in a motor-driven manner into the necessary axial position in the mixing chamber 2.4 and finally immovably fixed. The actuating drive 100 can be an electrically, pneumatically or hydraulically functioning actuator, which generates causatively a rotary or translatory adjustment movement. The arrangement of an oscillation sensor 200 and a control unit 300 with a control program 300a stored there was shown and described in FIG. 1. That information also applies analogously to the multi-stage injector 1. This also relates to the adjusting rod 5.2, which can be designed in the same manner as shown in FIG. 1.

In the annular inner housing 7, a first ring nozzle 4.1, which is connected on the radial outside with the outer annular space 3.3 of the second pressurization space 3 and which leads on the radial inside to the mixing chamber 2.4 via an unlabeled annular-gap-shaped first outlet opening, is formed on the right-side end. Via this first ring nozzle 4.1, the vaporous heat carrier D, coming from the vapor inlet D(E), is suctioned by the flow of the liquid product P escaping the first inner annular space 2.3 designed in a nozzle-like manner and functioning as a propulsion jet. The liquid product P is introduced via the product inlet P(E). The suction is generated by a drop in the pressure in the liquid product P, which is generated by an increase in the speed in the passage cross-section of the mixing chamber 2.4 in the area of the annular-gap-shaped first outlet opening. The first inner annular space 2.3 designed in a nozzle-like manner generally generates a related speed increase in the area of the annular-gap-shaped first outlet opening, which is considerably strengthened by a special action in the outlet end of the first inner annular space 2.3. This action consists in that an annular first nose 7.1a, which constricts there a first passage cross-section radially outwards such that it, seen in the direction of flow of the liquid product P, is made smaller with respect to the superordinate passage cross-section of the inner annular space 2.3, is designed on the inner housing 7 or respectively on the first housing ring 7.1, seen in the direction of flow of the liquid product P, directly in front of the annular-gap-shaped first outlet opening. The same structure in this area is also realized in the single-stage injector 1* according to FIG. 1.

The first annular nose 7.1a as well as, e.g., further noses 7.2a, 7.3a for ring nozzles 4.2, 4.3 arranged further downstream force the annular propulsion jet (liquid product P) in the area of the respective annular-gap-shaped outlet opening into a flow type, the flow cross-section of which, with respect to a plane running through the longitudinal axis of the mixing chamber 2.4, has an extension in the radial direction that is small with respect to an orthogonal second direction. The orthogonal second direction mainly corresponds with the direction of flow of the liquid product P.

The annular-gap-shaped first outlet opening flows into the mixing chamber 2.4 from the side of the surrounding inner housing 7, from radially outside, at a tilt angle α concordant to the direction of flow of the liquid product P. It is measured against the perpendicular line for the longitudinal axis of the mixing chamber 2.4, wherein it has proven advantageous when a value in the range of 30 to 45 degrees, preferably a value of 35 degrees, is provided for tilt angle α.

With respect to the direction of flow of the liquid product P, the downstream-side boundary surface of the annular-gap-shaped first outlet opening transitions into a first circumferential chamfer 7.2b on the inner housing 7, wherein the first chamfer 7.2b has a greater tilt with respect to the longitudinal axis of the mixing chamber 2.4 than the boundary surface of the inner housing 7 connecting to the first chamfer 7.2b. The transition between the downstream-side boundary surface of the annular-gap-shaped first outlet opening and the associated first chamfer 7.2b is rounded off with a relatively large radius.

The embodiment of the injector 1 according to the invention shown in FIGS. 2 and 3, seen in the direction of flow of the liquid product P, has two further ring nozzles 4.2 and 4.3 behind the first ring nozzle 4.1, which introduce the vaporous heat carrier D from the outer annular space 3.3 of the second pressurization space 3 into the still unbranched flow of the liquid product P respectively at tilt angle α. The surroundings of the second ring nozzle 4.2 and of the third ring nozzle 4.3 are each designed identical to the first ring nozzle 4.1, wherein this area of the ring nozzle 4.1 in FIG. 3 described above is labeled with “X.” This relates to an annular-gap-shaped second outlet opening, an annular second nose 7.2a and a circumferential second chamfer 7.3b in connection with the second ring nozzle 4.2, and an annular-gap-shaped third outlet opening, an annular first nose 7.3a, as well as a circumferential third chamfer 7.4b in connection with the third ring nozzle 4.3. The annular second nose 7.2 thereby forms a second passage cross-section directly before entering the mixing chamber 2.4 and the annular third nose 7.3a forms a corresponding third passage cross-section, which constricts the mixing chamber 2.4 respectively at the respective spot such that each cross-section, seen in the direction of flow of the liquid product P, is made smaller with respect to the superordinate passage cross-section of the mixing chamber 2.4.

The annular inner housing 7 (FIG. 2) consists of separate housing rings 7.1, 7.2, 7.3, 7.4, which, seen in the direction of flow of the liquid product P, are strung together and are each interspaced axially via a distributor ring 9 in the area of the respective ring nozzle 4.1, 4.2, 4.3, wherein the respective inner boundary surface of the housing rings 7.1, 7.2, 7.3, 7.4 is designed in a truncated-cone-shaped manner. Each respective axial spacing of the housing rings 7.1, 7.2, 7.3, 7.4 generates a circumferential annular gap, which forms the respective ring nozzle 4.1, 4.2, 4.3.

In cooperation with a preferably cylindrically designed section of the displacement body 5.1, the nozzle-shaped first inner annular space 2.3 is designed in the first housing ring 7.1, while the second housing ring 7.2, the third housing ring 7.3 and the fourth housing ring 7.4, seen in the direction of flow of the liquid product P and respectively in cooperation with the displacement body 5.1, tapering behind the first ring nozzle 4.1 and approximately parallel to the inner cone-shaped boundary surface of the respective associated housing ring 7.2 to 7.3, form an inner second annular space 2.4.1 or respectively an inner third annular space 2.4.2 or respectively an outlet chamber 2.4.3 on the inside. The first inner annular space 2.3, inner second annular space 2.4.1, inner third annular space 2.4.2 and outlet chamber 2.4.3 on the inside together form the mixing chamber 2.4. Through the design of the first pressurization space 2 described above, this area continuously tapers, seen the direction of flow of the liquid product P, in its extension area penetrated by the displacement body 5.1.

The respective inlet of the ring nozzle 4.1, 4.2, 4.3 is surrounded by the distributor ring 9 engaging outside radially into the inner housing 7, which has a plurality of preferably evenly spaced ring bore holes 9a distributed over its perimeter, each of which connect the ring nozzle 4.1, 4.2, 4.3 with the second pressurization space 3. The most even possible distribution of the vaporous heat carrier D within the respective associated ring nozzle is thereby achieved.

In order to ensure an even distribution of the vaporous heat carrier D from the outer annular space 3.3 of the second pressurization space 3 to the parallel-connected ring nozzles 4.1, 4.2 and 4.3, a baffle plate 8 with a plurality of distributor bore holes 8a is arranged in a sieve-like manner, seen in the direction of flow of the vaporous heat carrier D and before its entry into the second pressurization space 3. The baffle plate 8 almost completely fills the passage cross-section of the conical expansion fitting 6.5 connecting to the second inlet 6.4. The baffle plate 8 is thereby preferably folded in a V-shaped manner and the folding edge preferably progresses in the plane of the largest diameter of the conical expansion fitting 6.5.

A reference list for the abbreviations and drawing labels is as follows:
1* Single-stage injector
1 Multi-stage injector
2 First pressurization space (product)
2.1 First cylindrical inlet space
2.2 Inlet chamber
2.3 First inner annular space
2.4 Mixing chamber (annular-channel-shaped)
2.4.1 Second inner annular space
2.4.2 Third inner annular space
2.4.3 Outlet chamber
2.5 Cylindrical outlet space
3 Second pressurization space (water vapor)
3.1 Second cylindrical inlet space
3.2 Conically expanded space
3.3 Outer annular space
4.1 First ring nozzle
4.2 Second ring nozzle
4.3 Third ring nozzle
5 Mandrel
5.1 Displacement body
5.2 Adjusting rod
5.2a Guide rod
5.2b Fastening rod
6 Injector housing
6a Casing part
6b Collar part
6.1 Inlet housing
6.2 Cover
6.3 First inlet
6.4 Second inlet
6.5 Expansion fitting
6.6 Outlet
6.7 Tube extension
7 Inner housing
7.1 First housing ring
7.2 Second housing ring
7.3 Third housing ring
7.4 Fourth housing ring
7.1a First annular nose
7.2a Second annular nose
7.3a Third annular nose
7.2b First circumferential chamfer
7.3b Second circumferential chamfer
7.4b Third circumferential chamfer
8 Baffle plate
8a Distributor bore hole
9 Distributor ring
9a Ring bore hole
10 Lamp housing
11 Fastening part
14 First clamping ring
15 Second clamping ring
16 First clamping bushing
17 Second clamping bushing
18a First housing seal
18b Second housing seal
18c Third housing seal
18d Fourth housing seal
18e Fifth housing seal
19 Rod seal
20 Guide ring
21 Seal
100 Actuating drive
200 Oscillation sensor
300 Control unit
300a Control program
D Vaporous heat carrier (water vapor; culinary saturated vapor); second working fluid
D(E) Vapor inlet
P Liquid product; first working fluid
P(E) Product inlet
P(A) Product outlet
T(D(E)) Inlet temperature of the vaporous heat carrier D
T(P(A)) O utlet temperature of the liquid product P
ΔT Temperature difference (ΔT=T(D(E))−T(P(A)))
α Tilt angle
f Oscillation frequency
p(D(E)) Inlet pressure of the vaporous heat carrier D
p(P(A)) Outlet pressure of the heated liquid product P
Δp Pressure difference (Δp=p(D(E))−p(P(A)))
v Adjustment movement

1. A method with an injector for introducing a vaporous heat carrier into a liquid product including a food product or beverage, in which the vaporous heat carrier heats the liquid product in order to form a germ-free product, the method comprising:
generating flow of at least one of the vaporous heat carrier through a decrease in pressure, which occurs through a speed of the liquid product, or
the liquid product through a decrease in pressure, which occurs through a speed of the vaporous heat carrier;
producing a two-phase mixture comprising the liquid product and the vaporous heat carrier that flows through a mixing chamber extending in a direction of flow, the mixing chamber having an annular-channel shape and formed between a housing of the injector and a spiniform displacement body, the spiniform displacement body axially displaceable in the direction of flow such that a movement of the spiniform displacement body in the direction of flow effectuates a reduction in a passage cross-section of the mixing chamber and a movement against the direction of flow effectuates an increase in the passage cross-section of the mixing chamber;
capturing at least one:
an oscillation frequency of the injector as a whole or of a select part of the injector generated and forced by flow in the injector;
a temperature difference between an inlet temperature of the vaporous heat carrier at an inlet to the injector and an outlet temperature of the liquid product at an outlet from the injector; or
a pressure difference between an inlet pressure of the vaporous heat carrier at the inlet to the injector and an outlet pressure of the liquid product at the outlet from the injector;
and
depending on one or more of these physical measurement variables, automatically controlling axial movement of the displacement body in such as way that a heat transfer capacity from the vaporous heat carrier into the liquid product remains the same.

2. The method according to claim 1, wherein:
heating of the liquid product by the vaporous heat carrier takes place in more than one mixing chamber, which are connected in series in the direction of flow.

3. The method according to claim 1, wherein:
automatically controlled movement of the displacement body is performed when a temperature at the outlet from a heat-retaining path subordinate to the injector, seen in the direction of flow of the liquid product is exceeded with respect to the outlet temperature of the liquid product at the outlet from the injector by a specified temperature difference.

4. An apparatus with an injector for introducing a vaporous heat carrier into a liquid product, in particular a food product or beverage, in which the vaporous heat carrier heats the liquid product in order to form a germ-free product and in which a flow of the vaporous heat carrier is generated through a decrease in pressure, which occurs through a speed of the liquid product, comprising:
an injector housing, which has a first inlet for the liquid product and a second inlet for the vaporous heat carrier;
a first pressurization space having an outlet in the injector housing that is designed in a nozzle-like manner on an inlet side, and is connected with the first inlet;
an mixing chamber that has an annular-channel shape, which is part of a first pressurization space and which is formed between a rotationally symmetrical displacement body moveable in the axial direction on one side and an annular inner housing surrounding the first pressurization space on the other side;
an annular second pressurization space formed between the inner housing and the injector housing surrounding the inner housing, which is connected with the second inlet;
at least one ring nozzle, which, seen in the direction of flow of the liquid product, are arranged interspaced in a case of multiple arrangement, are respectively pressurizable by the vaporous heat carrier, are designed in or on the inner housing and are connected with the second pressurization space and which flow into the mixing chamber from a side of the inner housing surrounding the mixing chamber;
a displacement body that can be moved in a motor-driven manner, and
is connected with an actuating drive via an adjusting rod; and
a control unit in which least one of:
an oscillation frequency of the injector as a whole or of a select part of the injector generated and force by flow in the injector;
a temperature difference between an inlet temperature of the vaporous heat carrier at an inlet to the injector and an outlet temperature of the liquid product at an outlet from the injector; or
a pressure difference between an inlet pressure of the vaporous heat carrier at the inlet to the injector and an outlet pressure of the liquid product at the outlet from the injector are saved;
and in which a control program is stored, wherein
the control unit via an actuating drive performs an axial adjustment movement of the adjusting rod according to specifications by the control program and depending on one or more of the physical measurement variables.

5. The apparatus according to claim 4, further comprising:
an oscillation sensor arranged directly or indirectly on the injector housing.

6. The apparatus according to claim 5, wherein:
the oscillation sensor is connected directly or indirectly with the adjusting rod.

7. The apparatus according to claim 4, wherein:
components of the injector coming in contact with the liquid product are made of polyether ether ketone (PEEK).
